(19) United States
(12) Patent Application Publication
(10) Pub. No.: US 2026/0360969 A1
(43) Pub. Date: Nov. 12, 2026

(54) APPARATUS FOR RECEIVING SATELLITE SIGNALS ONBOARD A MOTOR VEHICLE, AND MOTOR VEHICLE COMPRISING SUCH APPARATUS

(71) Applicant: ASK INDUSTRIES S.P.A., REGGIO EMILIA (IT)

(72) Inventors: Paolo FACCHINI, REGGIO EMILIA (IT); Matteo CERRETELLI, SESTO FIORENTINO (IT); Fabio CASOLI, REGGIO EMILIA (IT); Andrea NOTARI, SCANDIANO (IT)

(21) Appl. No.: 19/647,283

(22) Filed: Apr. 14, 2026

(30) Foreign Application Priority Data
May 9, 2025 (IT) 102025000010539

(51) Int. Cl. H01Q 1/32; H01Q 5/20

(52) U.S. Cl. CPC H01Q 1/3275; H01Q 5/20

(57) ABSTRACT

Apparatus for receiving satellite signals onboard a motor vehicle having a wall with at least a first layer of glass or glass fiber-containing material with a first lower surface and a first upper surface. The apparatus includes an antenna device and a first predetermined area. The antenna device includes a signal processing electronic circuit and a receiver suitable for receiving satellite signals and transmitting the received signals to the signal processing electronic circuit. The first predetermined area is suitable for conveying the satellite signals to the receiver. The first predetermined area is defined at the first lower surface and is free of electrically conductive material. A perimeter edge of the first predetermined area is surrounded perimeterally by electrically conductive material. The receiver is positioned within a projection of the perimeter edge of the first predetermined area and faces and is spaced from the first lower surface by a predetermined distance.

### CROSS-REFERENCE TO RELATED APPLICATION(S)

This application claims priority under 35 U.S.C. § 119 to: Italian Patent Application No.: 102025000010539, filed on 9 May 2025, which is herein incorporated by reference.

### TECHNICAL FIELD

The present disclosure relates to an apparatus for receiving satellite signals onboard a motor vehicle, and to a motor vehicle comprising such an apparatus.

The apparatus according to the disclosure is particularly suitable for being used in motor vehicles and for being installed at a portion of the glass roof of such motor vehicles, and it will be described hereinafter with reference to this use without intending to limit the possible applications.

Indeed, as it will result clear in the following description, the apparatus according to the disclosure can be used in other types of motor vehicles, such as buses, trucks, commercial vehicles, et cetera, and it can be installed at other glass surfaces of the motor vehicles, such as, e.g. the windshield, the thermal rear window.

### BACKGROUND

It is well known in the state of the art the use of antennas or devices using antennas for receiving satellite signals on motor vehicles, e.g. for the navigation or radio communication.

For example, to this aim at least one antenna is fixed on a glass of a motor vehicle in order to be exposed as much as possible to the external environment from which the satellite signals to be received come from.

Although existing solutions fulfill such function properly, there are still some aspects that could be furtherly improved.

In particular, the presence of one or more glass plates or of glass fiber-comprising materials at the radiant element of the antenna causes changes in the performance, for example in terms of gain levels and of pattern of the radiations, which could possibly result critical or not optimal for the satellite services anyway.

These changes depend on several variables, such as for example the thickness, inclination, dimension and curvature of the plates made of glass or containing glass fibers.

Therefore, the aim of the present disclosure is to provide a solution that, compared to the known solutions, allows to improve the reception of satellite signals onboard motor vehicles, or, in any case, to offer an alternative solution that is effective and relatively easy to implement and install.

### SUMMARY

The present disclosures provides an apparatus for receiving satellite signals onboard a motor vehicle which comprises a wall that includes at least a first layer made of glass or glass fiber-containing material and has a first lower surface and a first upper surface, the apparatus comprising at least:
an antenna device comprising at least a signal processing electronic circuit and a receiver suitable for receiving said satellite signals and transmitting the received satellite signals to said signal processing electronic circuit;
a first predetermined area which is suitable for conveying the satellite signals to said receiver, wherein the first predetermined area is defined at said first lower surface and is free of electrically conductive material, the perimeter edge of said first predetermined area being surrounded perimeterally by electrically conductive material; and wherein at least the receiver is positioned within the projection of the edge of the first predetermined area and faces and is spaced from said first lower surface by a predetermined distance.

According to some examples, the apparatus according to the present disclosure may comprise one or more of the following features, which may be combined in any technical feasible and even partial combination:
the first predetermined area has a substantially circular or elliptical shape having diameter or respectively major axis of predetermined length;
the ratio of the predetermined length to the wavelength of the receiver at the center frequency of the working frequency band is between 0.4 and 2.3;
the ratio of the predetermined length to the wavelength of the receiver at the center frequency of the working frequency band is between 0.8 and 1.9;
the ratio of the predetermined length to the wavelength of the receiver at the center frequency of the working frequency band is between 0.9 and 1.2;
the distance of the receiver from the first lower surface of the first layer has a value greater than zero and less than or equal to the wavelength A of the receiver at the center frequency of the working frequency band;
when the wall of the vehicle includes at least a second layer made of glass or glass fiber-containing material which is superimposed on the first layer and has a second lower surface and a second upper surface, the apparatus further comprises a second predetermined area suitable for conveying satellite signals to the receiver, the second predetermined area being defined at the second lower surface and being free of electrically conductive material, and wherein the perimeter edge of the second predetermined area is surrounded perimeterally by electrically conductive material;
the second predetermined area has a substantially circular or elliptical shape and is arranged substantially concentrically or coaxially with the first predetermined area;
the second predetermined area has diameter or respectively major axis of predetermined length greater than the predetermined length of the diameter or respectively major axis of the first predetermined area;
the apparatus comprises at least one circular sector made of electrically conductive material which is arranged around and surrounds the perimeter edge of the first predetermined area;
the ratio of the difference of the outer radius and the inner radius of said circular sector to the wavelength of the receiver at the center frequency of the working frequency band is between 0.1 and 0.4;
the ratio of the difference of the outer radius and the inner radius of said circular sector to the wavelength of the receiver at the center frequency of the working frequency band is between 0.15 and 0.35.

In another aspect, the present disclosure provides also a motor vehicle comprising at least one apparatus as above defined.

### BRIEF DESCRIPTION OF THE DRAWINGS

Further features and advantages of the disclosure will appear in the following detailed description, made by way of non-limiting example, with reference to the attached drawings, wherein:

FIG. 1 is a view which schematically illustrates an apparatus according to the disclosure used at the roof of a motor vehicle;

FIGS. 2-7 are enlarged views of the area A of FIG. 1 which illustrate possible embodiments of an apparatus according to the disclosure.

### DETAILED DESCRIPTION

It should be noted that in the following detailed description, identical or similar components, from a structural and/or functional point of view, can have the same or different reference numbers, independently of the fact that they are shown in different embodiments of the present disclosure or in separated parts.

It should also be noted that, to clearly and concisely describe the present disclosure, the drawings could be not up to scale and some features of the description could be shown in a somehow schematic form.

Moreover, when the term “adapted”, or “configured”, or “shaped” or a similar term is used in the present document, with reference to any component as a whole, or to any part of a component or of a combination of components, it should be intended that it means and correspondingly comprises the structure and/or configuration and/or shape and/or positioning.

Moreover, when the term “substantial” or “substantially” is used herein, this should be intended as comprising an actual variation of more or less 5% with respect to what has been indicated as reference value or position, and when the terms “transverse” or “transversely” are used herein, they should be intended as comprising a direction which is non parallel to the reference part(s) or direction(s)/axis which they are referred to, and the perpendicularity is to be considered a specific case of transverse direction.

Lastly, in the following direction and claims, the ordinal numbers first, second, et cetera, will be used for the sake of illustrative clarity and in no way they should be intended as limiting for any reason; in particular, the indication for example of a “first glass layer . . . ” does not necessarily imply the presence or the strict need of a further “second glass layer”, unless this presence is not clearly evident for the correct functioning of the described embodiments, nor that the order needs to be exactly the one in the described sequence, with reference to the illustrative embodiments described.

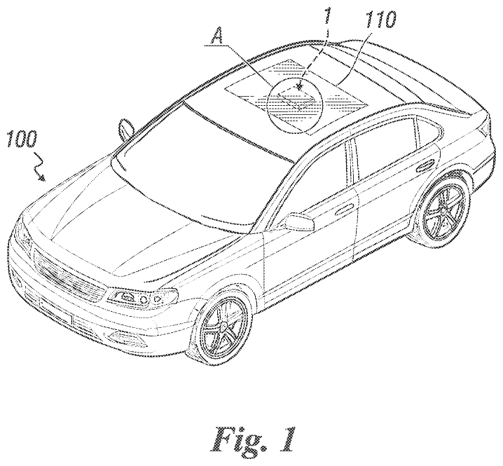

FIG. 1 schematically illustrates an apparatus 1 for receiving satellite signals onboard a motor vehicle, for example a car schematically represented by the reference number 100.

In the exemplary embodiment of FIG. 1, the apparatus 1 is illustrated installed (see the circled area A) at a portion of the roof 110 of the car 100.

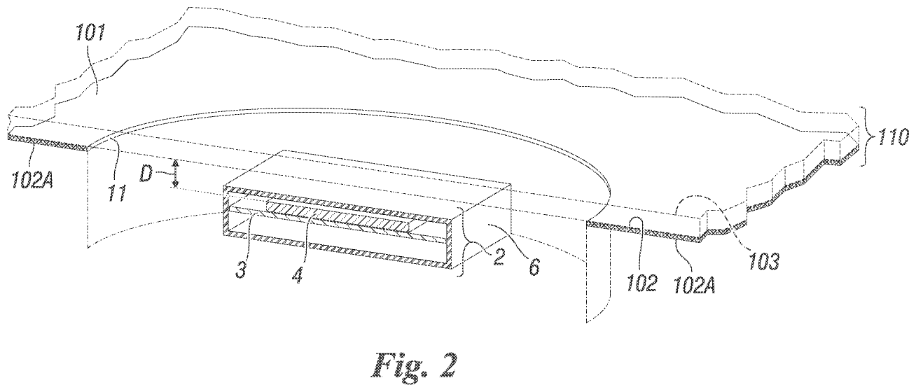

As schematically illustrated in FIGS. 2-7, at least one portion of the roof 110 of the car 100 comprises at least a first glass layer or of a glass fiber-containing material 101, which has a first lower surface 102 and a first upper surface 103.

The definition of lower and upper surfaces should be intended with reference for example to the interior of the car, the inner surface being the closest to the internal space of the car interior, or in any case with respect to a lateral view of the car 100 (i.e., on the side of the doors).

Clearly, as mentioned before, depending on the applications, for example on the type of motor vehicle, the apparatus 1 according to the disclosure could be installed at other surfaces made of glass, for example the windshield, the thermal rear window, etc., or of a material made of or at least containing glass fibers, such as car spoilers, rear tailgates or trunks.

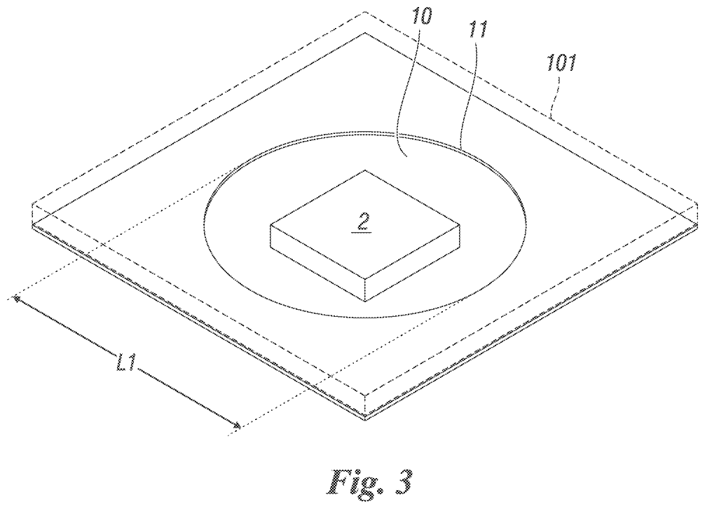

Advantageously, as illustrated for example in FIGS. 2-3, the apparatus 1 according to the disclosure comprises at least:
an antenna device 2 comprising at least a signal processing electronic circuit 3 and a receiving element or receiver 4 (hereinafter “receiver 4”) suitable for receiving satellite signals and transmitting them to the signal processing electronic circuit 3;
a first predetermined area, illustrated in FIG. 3 by the reference number 10, suitable for conveying satellite signals to the receiver 4.

In particular, the predetermined area 10 is defined at, i.e. along, the first lower surface 102 and it is free of electrically conductive material.

The perimeter edge 11 of said first predetermined area 10 is surrounded around its perimeter by electrically conductive material.

The electrically conductive material that surrounds the perimeter edge 11 extends radially around and from the perimeter edge 11 along at least a portion of the first lower surface 102.

At least the receiver 4 of the antenna device 2 is positioned inside the projection of the perimeter edge 11 of the first predetermined area 10 and is facing to and it is distant by a predetermined distance D from the first lower surface 102.

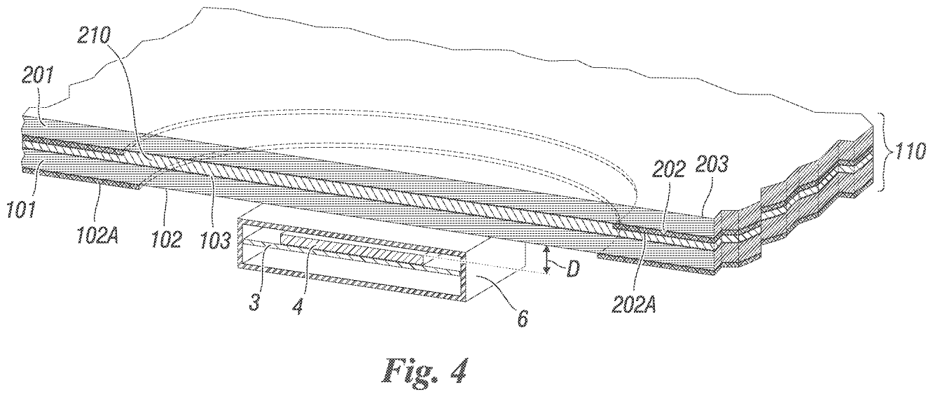

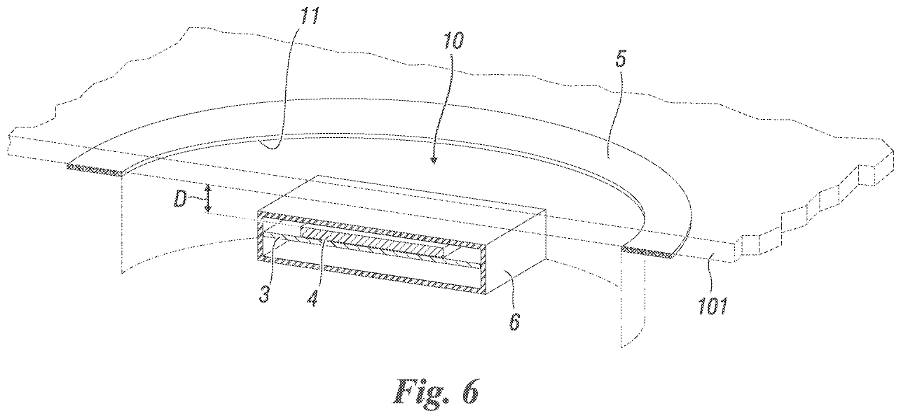

In FIGS. 2 and 6 (but the same applies for the exemplary embodiment of FIG. 4), such projection of the edge 11 is schematically illustrated by the dashed lines 15, and it is, for example, to be considered obtained by lines passing by each point of the edge 11 and substantially perpendicular to the middle plane where there lies the area 10 itself.

In particular, as schematically highlighted in FIG. 2, in the case wherein the first lower surface 102 of the wall 101 is at least partially covered by a sheet made of metallized plastic material or by a metallization layer 102A, e.g. of an electrically conductive material layer, the first predetermined area 10 is formed by an aperture derived in that sheet or layer 102A that is therefore not covered by that electrically conductive material.

In a possible embodiment, the first predetermined area 10 has a substantially circular or elliptical shape which has the diameter or the major axis, respectively, of a predetermined length, indicated in FIGS. 2, 4 and 6 by the reference L1.

Usefully, the ratio between the predetermined length L1 and the wavelength λ of the receiver 4 at the central frequency of the working frequencies band is comprised between 0,4 and 2,3, preferably between 0,8 and 1,9, more preferably between 0,9 and 1,2.

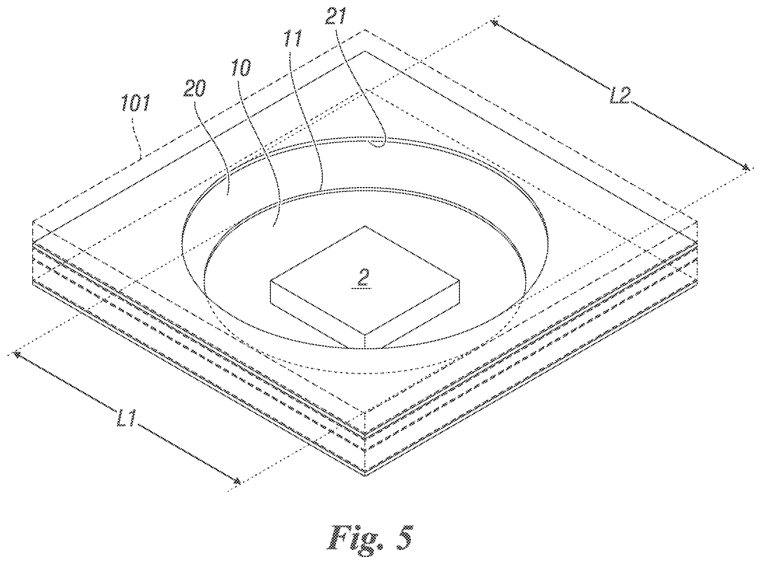

Conveniently, the distance D mentioned above of the receiver 4 from the first lower surface 102 has a not null value (i.e. higher than zero) and lower or equal to the wavelength A of the receiver 4 at the central frequency of the working frequencies band. FIGS. 4 and 5 illustrate a possible embodiment of the apparatus 1 according to the disclosure when the glass wall of the motor vehicle 100 used to install the apparatus 1, for example the roof 110, presents a structure with more glass layers or of glass fiber-containing material.

In this case, the wall 110 includes at least a second layer 201, made of glass or of glass fiber-containing material, which is overlapped to the first layer 101, for example with interposition of a plastic layer 210 between them, and that has a second lower surface 202 and a second upper surface.

In this case, the apparatus 1 further comprises a second predetermined area 20 (illustrated in FIG. 5 with a dashed line) which is defined at the second lower surface 202 in the area where the first area 10 is defined.

Similarly to the first area 10, the second predetermined area 20 is also suitable for conveying the satellite signals to the receiver 4.

Usefully, also the second predetermined area 20 is free of electrically conductive material, and its perimeter edge 21 can be surrounded around the perimeter by electrically conductive material.

Also in this case, the electrically conductive material that surrounds the second predetermined area 20 extends radially around and from the perimeter edge 21 along at least a portion of the second lower surface 202.

According to a possible embodiment, the second predetermined area 20 has an extension bigger than that of the first predetermined area 10.

According to a possible embodiment, the second predetermined area 20 has a substantially circular or elliptical shape and it is placed substantially concentrically or coaxially to the first predetermined area 10.

In particular, the second predetermined area 20 has the diameter or respectively the major axis with a predetermined length L2 longer than the predetermined length L1 of the diameter or respectively the major axis of the first predetermined area 10.

In particular, as schematically highlighted in FIG. 4, in the case wherein the second lower surface 202 of the wall 101 is at least partially covered by a metallized plastic material sheet or by a metallization layer 202A, e.g. by an electrically conducing material, the second predetermined area 20 is formed by an aperture derived in that layer 202A that is therefore not covered by such electrically conducing material.

If the wall made of glass or made of a glass fiber-containing material used for the installation of the apparatus 1, for example the roof 110, has further layers similar to the layers 101 and 201, the apparatus 1 according to the disclosure is designed such that a predetermined area is formed at each lower surface of every layer, for example of a shape similar to the first and second areas 10 and 20, e.g. circular or elliptical, with a longer diameter or major axis with respect to the one of the predetermined area of the layer immediately below.

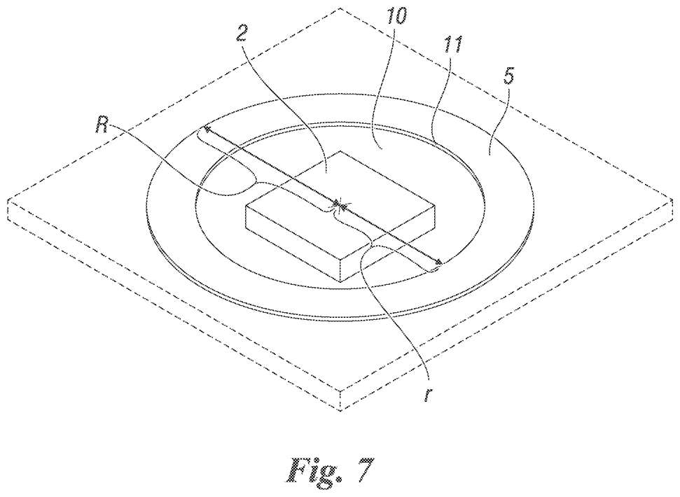

In a possible embodiment, as for example illustrated in FIGS. 6 and 7, in the case wherein the wall used to install the apparatus 1, for example the roof 110, is made only of a dielectric material, the apparatus 1 comprises at least a circular sector or annulus 5 which is made of an electrically conductive material and it is placed around and surrounds the perimeter edge 11 of the first predetermined area 10.

In a possible embodiment, the ratio between the double of the inner radius (and therefore of the diameter) of the circular sector or annulus 5 and the wavelength A of the receiver 4 at the central frequency of the working frequencies band, is comprised between 0,4 and 2,3, preferably between 0,8 and 1,9, and further more preferably between 0,9 and 1,2.

In particular, the ratio between the thickness of the circular sector or annulus 5 (given by the difference of the outer radius and inner radius) and the wavelength λ of the receiver 4 at the central frequency of the working frequencies band is comprised between 0,1 and 0,4, preferably between 0,15 and 0,35.

In a possible embodiment, the antenna device 2 is a patch antenna or a combination of more patch antennas piled one on top of another one, i.e. in a stacked configuration.

In a possible embodiment, the at least one electronic circuit 3 is also placed inside the projection of the perimeter edge 11 of the first predetermined area 10.

In a possible embodiment, as for example illustrated in FIGS. 2, 4 and 6, the receiver 4 of the antenna device 2 comprises or is constituted by a substantially flat element made of a metallic material.

In a possible embodiment, the at least one electronic circuit 3 is for example an amplifier circuit, suitable for amplifying the signals received by the receiver 4.

In a possible embodiment, the at least one electronic circuit 3 comprises or is constituted by a printed circuit board.

In a possible embodiment, the receiver 4 is placed on the electronic circuit 3, for example on the printed circuit board.

Moreover, the antenna device 2 comprises a containment casing 6, which houses at least the receiver 4 and the processing circuit 3.

In particular, according to a possible embodiment, the containment casing 6 is placed inside the projection of the perimeter edge 11 of the first predetermined area 10.

According to known or easily-implementable embodiments for the person skilled in the art, the containment casing 6 can be realized in any material suitable for the aim, for example plastic, and it can be realized for example by two half-shells coupled with each other, possibly also made of different materials, for example the upper one could be made of plastic and the lower one could be made of metal.

Moreover, the casing 6 can be fixed for example mechanically to the roof of the car 100 with the components housed inside, according to known or easily-implementable embodiments for a person skilled in the art and therefore they are not described in detail herein.

It has been practically seen as the apparatus 1 according to the disclosure allows to appropriately fulfill the predefined aim in that it presents a structure which is easily-implementable and affordable, which allows to optimize, in a relatively simple and effective way, the reception of satellite signals onboard motor vehicles.

In particular, the presence of one or more predetermined areas free of electrically conductive material, as described and sized above, allows to produce a more uniform radiation diagram and that more closely resembles the behavior that would be observed in the absence of glass or of glass fiber-containing material.

This allows to compensate the negative effect of the presence of such material, allowing a good satellite reception from every relevant direction of origin, i.e. every direction above the horizon, starting from the ones with lower elevation angles, until the zenith.

Of course, without prejudice to the principle of the disclosure, the actuation embodiments and the embodiment particulars can be widely varied with respect to what has been described and illustrated by way of non-limiting example, without for this reason exiting the field of protection of the present disclosure defined by the appended claims, comprised any possible combination, also partial, of the previously described embodiments.

1. An apparatus for receiving satellite signals onboard a motor vehicle which comprises a wall that includes at least a first layer made of glass or glass fiber-containing material and has a first lower surface and a first upper surface, the apparatus comprising at least:
an antenna device comprising at least a signal processing electronic circuit and a receiver suitable for receiving said satellite signals and transmitting the received satellite signals to said signal processing electronic circuit;
a first predetermined area which is suitable for conveying the satellite signals to said receiver, wherein the first predetermined area is defined at said first lower surface and is free of electrically conductive material, the perimeter edge of said first predetermined area being surrounded perimetrically by electrically conductive material; and wherein at least the receiver is positioned within a projection of an edge of the first predetermined area and faces and is spaced from said first lower surface by a predetermined distance.

2. The apparatus according to claim 1, wherein said first predetermined area has a substantially circular or elliptical shape with a diameter or major axis, as the case may be, of predetermined length.

3. The apparatus according to claim 2, wherein the ratio of said predetermined length to a wavelength of the receiver at a center frequency of working frequency band is between 0.4 and 2.3.

4. The apparatus according to claim 2, wherein the ratio of said predetermined length to the wavelength of the receiver at the center frequency of the working frequency band is between 0.8 and 1.9.

5. The apparatus according to claim 2, wherein the ratio of said predetermined length to the wavelength of the receiver at the center frequency of the working frequency band is between 0.9 and 1.2.

6. The apparatus according to claim 1, wherein said predetermined distance of the receiver from the first lower surface of the first layer has a value greater than zero and less than or equal to the wavelength of the receiver at the center frequency of the working frequency band.

7. The apparatus according to claim 1, wherein the wall of the vehicle includes at least a second layer made of glass or glass fiber-containing material which is superimposed on said first layer and has a second lower surface and a second upper surface, and wherein the apparatus further comprises a second predetermined area suitable for conveying satellite signals to said receiver, the second predetermined area being defined at said second lower surface and being free of electrically conductive material, and wherein a perimeter edge of said second predetermined area is surrounded perimetrically by electrically conductive material.

8. The apparatus according to claim 7, wherein said second predetermined area has a substantially circular or elliptical shape and is arranged substantially concentrically or coaxially with said first predetermined area.

9. The apparatus according to claim 8, wherein said second predetermined area has a diameter or major axis, as the case may be, of predetermined length greater than the predetermined length of the diameter or major axis, as the case may be, of the first predetermined area.

10. The apparatus according to claim 1, comprising at least one circular sector made of electrically conductive material which is arranged around and surrounds the perimeter edge of said first predetermined area.

11. The apparatus according to claim 10, wherein a ratio of a difference of an outer radius and an inner radius of said circular sector to a wavelength of the receiver at a center frequency of a working frequency band is between 0.1 and 0.4.

12. The apparatus according to claim 10, wherein the a ratio of a difference of an outer radius and an inner radius of said circular sector to a wavelength of the receiver at a center frequency of a working frequency band is between 0.15 and 0.35.

13. A motor vehicle comprising at least one apparatus according to claim 1.
